(19) United States
(12) Patent Application Publication
(10) Pub. No.: US 2008/0116392 A1
(43) Pub. Date: May 22, 2008

(54) METHOD AND SYSTEM FOR WIDE-FIELD MULTI-PHOTON MICROSCOPY HAVING A CONFOCAL EXCITATION PLANE

(75) Inventor: Gary Brooker, Rockville, MD (US)

Correspondence Address: OBLON, SPIVAK, MCCLELLAND MAIER & NEUSTADT, P.C., 1940 DUKE STREET, ALEXANDRIA, VA, 22314, US

(73) Assignee: Celloptic, Inc., Rockville, MD (US)

(21) Appl. No.: 11/561,766

(22) Filed: Nov. 20, 2006

(51) Int. Cl. G21K 5/04; G02B 13/14

(52) U.S. Cl. 250/458.1; 250/215; 359/356

(57) ABSTRACT

A wide field microscope includes a stage configured to hold a specimen having a fluorescent material therein, and a multi-photon excitation light source configured to produce excitation light having a single photon energy less than an absorption energy required for single photon excitation of said fluorescent material. A beam expansion unit is optically coupled to the light source and configured to expand the excitation light with reduced pulse spreading characteristics, and an infinity corrected objective optically coupled to the expansion unit and configured to focus the excitation light onto the specimen such that multi-photon excitation of the fluorescent material simultaneously occurs over a predetermined area of the specimen. A focus lens is configured to focus emission light emitted from said predetermined area of the specimen onto at least two pixels of an image detector simultaneously.

### BACKGROUND OF THE INVENTION

1. Field of the Invention

The present invention relates generally to fluorescence microscopy, and more specifically to providing wide field multi-photon fluorescence excitation in a confocal plane.

2. Discussion of the Background

Optical microscopy has long been used for inspecting objects too small to be seen distinctly by the unaided eye. Optical microscopy involves providing a light beam incident on a specimen and viewing the light from the specimen through a magnifying lens. Fluorescence microscopy is another type of microscopy in which a fluorescent material is used to mark the specimen or objects in the specimen of interest, which is then illuminated with a wavelength of light that provides a single photon energy level sufficient to excite the fluorescent material to emit emission light. The image of the specimen is detected by collecting the emission light rather than the excitation light. Fluorescence microscopy can be practiced as standard wide-field microscopy or confocal microscopy.

In wide-field fluorescence microscopy, an excitation light source, such as an arc lamp, provides a parallel or quasi-parallel excitation beam that is converged onto a desired focal plane of the specimen. The image at the focal plane results from all of the light encompassed by the point spread characteristic of a specific objective. Because the point spread function does not define a single plane of focus, excitation of the fluorescent material occurs above and below the desired focal plane and volume information of the specimen cannot be discerned. Computational methods commonly called deconvolution microscopy, which utilize a model of the objective's point spread function, can be used to calculate the light of a specific plane in the specimen from a stack of images taken at different planes of focus. This is done by accounting for the influence of light from each slice upon the other slices to approximate a confocal image slice of defined thickness. The performance of wide-field deconvolution confocal fluorescence microscopy can be similar to optical confocal microscopic methods, however in many cases the resultant image is not accurate because of the influence of image noise due to poor contrast caused by background emissions or because the point spread function for the objective may deviate from its respective model under actual experimental conditions. Moreover, these problems make 3-D representations of the specimen difficult to construct.

In confocal fluorescence microscopy, a beam of excitation light is focused on a focal point of the specimen. Where the excitation light has a wavelength sufficient to provide single photon excitation of the fluorescent material, excitation occurs in an hourglass beam waist centered at the focal point which approximates the point spread function of the objective. Unlike wide-field fluorescence microscopy, however, confocality can be obtained by using a pinhole aperture for the excitation source and emission image. Since only parallel light rays that originate from the plane of focus can pass through the pinhole, photons that do not have parallel rays (and are out of the plane of focus) are blocked by the pinhole aperture and do not reach the detector. Thus, the pinhole aperture blocks emission light from above and below the focus point thereby providing a clear image undistorted by information above and below the plane of focus. However, because the emission pinhole provides image data only from one plane of the point of focus of the laser beam, the excitation laser beam of a confocal system must be raster scanned in the x and y direction upon the sample and the fluorescent emission intensity collected at each x,y position. From this data an image slice of the specimen can be constructed in a computer. By changing the plane of focus, several images can be obtained and the resulting stack of images can be reconstructed in a computer to obtain a three dimensional (3-D) representation of the specimen.

One common problem with both wide-field and confocal fluorescence microscopy is that single photon excitation of the fluorescent material occurs above and below the point of focus where image data is actually collected. This unnecessary excitation causes “bleaching” of the material above and below a particular focal plane which when subsequently excited as part of a new focal plane will have reduced emission characteristics. Moreover repeated excitation of tissue above and below the focal plane can damage the tissue, which is particularly undesirable for image creation of live specimens.

Recently, multi-photon fluorescence microscopy has emerged as a new optical sectioning technique for reducing the problems of bleaching and tissue damage. This type of microscopy uses a pulsed illumination laser source having a longer wavelength than required for non pulsed excitation of the fluorescent material. For example, a dye normally requiring an excitation wavelength of 500 nm can be illuminated by a pulsed laser source operating at 1000 nm such that single photon excitation does not occur in the specimen since the dye does not absorb light at 1000 nm. However, the use of a pulsed high-power excitation laser provides a sufficiently high photon density at the point of focus for at least two photons to be absorbed (essentially simultaneously) by the fluorescent material. This absorption of two photons of long wavelength provides excitation energy equivalent to the absorption of a single photon of a shorter wavelength and results in excitation confined to the focal point. Thus with multi-photon excitation, fluorescent material surrounding the focal point is not excited thereby eliminating the need for a pinhole aperture to eliminate out of focus fluorescence. Because excitation does not occur above and below the plane of focus, it minimizes problems of photobleaching and tissue damage that occur from repeated excitation during single photon excitation.

FIG. 6 shows a multi-photon scanning microscopy system disclosed in U.S. Pat. No. 5,034,613. As seen in this figure, the scanning microscope 10 includes an objective lens 12 for focusing incident light 14 from a source 16 such as a laser onto an object plane 18. The illumination provided by incident light beam 14 fills a converging cone generally indicated at 24, the cone passing into the specimen to reach the plane of focus at object plane 18 and form focal point 26. The optical path from laser 16 to the object plane 18 includes a dichroic mirror 28 onto which the light from the laser 16 is directed. The mirror 28 deflects this light downwardly to a mirror 30 which in turn directs the light to a pair of scanning mirrors 32 and 34 by way of curved mirrors 36 and 38. The mirrors 32 and 34 are rotatable about mutually perpendicular axes in order to move the incident light 14 along perpendicular X and Y axes on the object plane so that the stationary specimen is scanned by the incident beam. The light from the scanning mirrors passes through eyepiece 40 and is focused through the objective lens 12 to the object plane 18.

Fluorescence produced in the specimen in the object plane 18 travels back through the microscope 10, retracing the optical path of the incident beam 14, and thus passes through objective lens 12 and eyepiece 40, the scanning mirrors 34 and 32 and the curved mirrors 38 and 36, and is reflected by mirror 30 back to the dichroic mirror 28. The light emitted by fluorescent material in the specimen is at a wavelength that is specific to the fluorophore contained in the specimen, and thus is able to pass through the dichroic mirror 28, rather than being reflected back toward the laser 16, and follows the light path indicated generally at 44. The fluorescent light 42 thus passes through a barrier filter 46 and is reflected by flat mirrors 48, 50 and 52 to a suitable detector such as a photomultiplier tube 54. While not necessary for multi-photon microscopy, an adjustable confocal pin hole 56 is provided in the collection optics 44 to minimize background fluorescence excited in the converging and diverging cones above and below the plane of focus.

### SUMMARY OF THE INVENTION

Despite the above described advantages of a multi-photon fluorescence microscopy system. The present inventor recognized that conventional systems of this type include complex and expensive excitation beam scanning mechanisms. Moreover, scanning of the focal point excitation light generally results in image acquisition speed that is too slow for video rate or higher speed imaging of the specimen.

Accordingly, one object of the present invention is to address the above described problems of prior art multi-photon fluorescence microscopy.

Another object of the present invention is to provide a method and system of multi-photon microscopy wherein scanning of the excitation light source over the specimen can be reduced or eliminated.

Yet another object of the invention is to reduce the image acquisition time for a specimen in multi-photon microscopy.

These and/or other objectives may be provided by a method and system for wide-field multi-photon microscopy having a confocal plane. According to one aspect of the invention, a wide field microscope includes a stage configured to hold a specimen having a fluorescent material therein, and a multi-photon excitation light source configured to produce excitation light having a single photon energy less than an absorption energy required for single photon excitation of said fluorescent material. A beam expansion unit is optically coupled to the light source and configured to expand the excitation light with reduced pulse spreading characteristics, and an infinity corrected objective optically coupled to the expansion unit and configured to focus the excitation light onto the specimen such that multi-photon excitation of the fluorescent material simultaneously occurs over a predetermined area of the specimen. A focus lens is configured to focus emission light emitted from said predetermined area of the specimen onto at least two pixels of an image detector simultaneously.

According to another aspect, a wide-field microscope includes means for holding a specimen having a fluorescent material therein, and means for producing a beam of excitation light having a single photon energy less than an absorption energy required for single photon excitation of the fluorescent material included in the specimen. Also included in this aspect is means optically coupled to the multi-photon excitation light source for receiving the beam of excitation light and expanding the excitation light into an expanded beam onto the specimen such that multi-photon excitation of the fluorescent material simultaneously occurs over a predetermined area of the specimen. Means for focusing focuses the emission light emitted from the predetermined area of the specimen onto at least a two by two array of pixels of an image detector simultaneously.

Another aspect of the invention includes a method of providing a wide-field excitation across a confocal plane. The method includes holding a specimen having a fluorescent material therein, producing a beam of excitation light having a single photon energy less than an absorption energy required for single photon excitation of the fluorescent material included in the specimen, and applying a beam of excitation light to an infinity corrected objective that focuses the excitation light onto the specimen such that multi-photon excitation of the fluorescent material simultaneously occurs over a predetermined area of the specimen. Emission light emitted from the predetermined area of the specimen is focused onto at least a two by two pixel array of an image detector simultaneously.

Another aspect of the invention includes a method of providing a wide-field excitation across a confocal plane. The method includes holding a specimen having a fluorescent material therein, producing a beam of excitation light having a single photon energy less than an absorption energy required for single photon excitation of the fluorescent material included in the specimen, and applying a beam of excitation light to a totally reflective infinity corrected objective that focuses the excitation light onto the specimen such that multi-photon excitation of the fluorescent material simultaneously occurs over a predetermined area of the specimen. Emission light emitted from the predetermined area of the specimen is focused onto at least a two by two pixel array of an image detector simultaneously.

Another aspect of the invention includes a wide-field microscope having a stage configured to hold a specimen having a fluorescent material therein, and a multi-photon excitation light source configured to produce a beam of excitation light having a single photon energy less than an absorption energy required for single photon excitation of the fluorescent material. An infinity corrected objective is optically coupled to the multi-photon excitation light source and configured to focus the substantially parallel beam of excitation light onto the specimen such that multi-photon excitation of the fluorescent material simultaneously occurs over a predetermined area of the specimen. A focus lens is configured to focus emission light emitted from the predetermined area of the specimen onto an image plane, such that the image plane can be viewed through a binocular eyepiece.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a system diagram of a multi-photon microscopy system in accordance with one embodiment of the invention;

FIG. 2 is a schematic diagram of one embodiment of the beam expansion system of a multi-photon microscopy system of the invention;

FIGS. 3a and 3b are schematic diagrams of two additional embodiments of the a multi-photon microscopy system in accordance with two additional beam expansion systems of the invention;

FIG. 4 is a system diagram of a multi-photon microscopy system in accordance with yet another embodiment of the multi-photon microscopy system invention including a lens free objective with reflective optics;

FIG. 5 shows different image planes from imaging 4 micron fluorescent beads with the multi-photon microscopy system of the present invention; and

FIG. 6 shows a prior art conventional multi-photon scanning microscopy system.

### DESCRIPTION OF THE PREFERRED EMBODIMENTS

As discussed above, conventional multi-photon fluorescence microscopy systems implement complex scanning of the sample by the excitation light source. Commonly assigned and co-pending application Ser. No. 10/847,862 (the '862 application) discloses that such complex microscopy systems result from a widely perceived need to limit multi-photon excitation to a small focus point of the specimen. However, the '862 application discloses that wide-field multi-photon microscopy which eliminates or reduces the need for scanning of the excitation light can be achieved by reducing pulse spreading of the excitation light and/or providing uniform characteristics across the excitation beam. the '862 application discloses an example wide field multi-photon microscopy system wherein multi-photon light is passed through a beam expander that can provide a substantially parallel excitation light beam with reduced pulse spreading and substantially homogeneous characteristics to the objective lens. While this system provides good wide field multi-photon characteristics that substantially reduce the need for scanning the excitation light, the present inventor has discovered that a converging beam of excitation light that maintains uniform pulse width across the field, provided into the objective lens can provide a wider field of view and greater fluorescence intensity, which can further reduce the need for scanning in a multi-photon microscopy system.

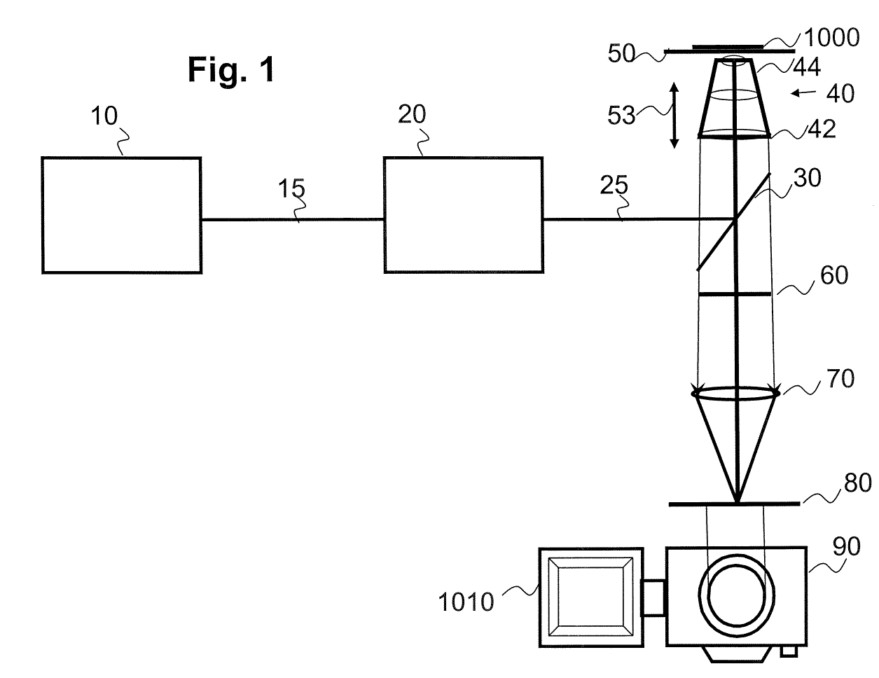

Referring now to the remaining drawings, wherein like reference numerals designate identical or corresponding parts throughout the several views, FIG. 1 illustrates a wide-field multi-photon microscopy system according to one embodiment of the present invention. As seen in this figure, pulsed laser excitation source 10 provides an excitation light beam 15, which is expanded by a beam expansion unit 20 which maintains the pulsed laser characteristics into an expanded excitation beam 25 that is applied to the dichroic mirror 30. The dichroic mirror 30 reflects the excitation beam 25 into the objective lens device 40, which applies the excitation light onto a specimen 1000 held on the stage 50. In the embodiment of FIG. 1, the objective 40 is movable along the axial direction of the excitation light beam to change the focus plane of the excitation light beam on the specimen 1000 as shown by arrow 53. The specimen absorbs at least 2 photons of the excitation light to cause the specimen to emit emission light which passes back through the objective 40, dichroic mirror 30 and emission filter 60 to tube lens 70. The tube lens 70 focuses the emission light 55 onto an image plane 80 where detector 90 can detect an image 1010 of an area of the specimen 1000.

The pulsed laser excitation light source 10 provides ultra-short laser pulses of a predetermined wavelength having a single photon energy level insufficient to cause excitation of the specimen. As a wide variety of fluorescent materials having different excitation characteristics can be added to a specimen, the operating wavelength of the laser excitation light source 10 depends on the fluorescence emission characteristics of the sample. Thus, the laser excitation light source 10 can operate at approximately 700 nm to approximately 1100 nm and is preferably tunable over this range. The short pulse of the laser excitation light source 10 may be in the picosecond, femtosecond or shorter pulse duration range, and may have a pulse repetition rate of up to 100 Mhz. In one embodiment, the laser excitation light source 10 can be implemented as a tunable titanium:sapphire mode-locked laser manufactured by Spectra-Physics of Mountain View California or by Coherent, Inc. of Santa Clara, Calif. However, any known laser for providing a short pulse excitation source for multi-photon excitation may be used. Further, excitation light may be provided by a high power arc lamp.

The beam expansion unit 20 expands the laser beam and can be configured to deliver either parallel or converging laser light, with reduced pulse spreading characteristics of the original pulsed laser source, to a back aperture of the objective. The present inventor discovered that presenting converging light to the back aperture of the objective with reduced pulse spreading can increase the maximum field of illumination, brightness of multiphoton fluorescence and enable use of the maximum design numerical aperture of the objective. As used herein, the term reduced pulse spreading characteristics means that the beam expansion unit provides expanded excitation light (either parallel or converging) with less pulse spreading characteristics than would result from a convex/concave lens system which that is not designed to minimize dispersion or maintain constant dispersion across the excitation beam. Pulse spreading characteristics include an overall amount of pulse spreading for the excitation light field or disparity of pulse spreading across the excitation, or a combination of these factors. In a preferred embodiment, the beam expander provides an expanded excitation beam that has substantially the same pulse width as the excitation light emitted from the pulsed laser source and/or has substantially the same disparity in pulse width as the excitation light emitted from the pulsed laser source.

Thus, in one embodiment, the beam expansion unit 20 is designed to provide the same focusing or convergence of the excitation light as a given convex lens system, but with an overall reduction in pulse spreading of the light when compared to the convex lens to allow multiphoton excitation across the image plane. The present inventor has determined that it is possible to expand or focus the laser beam without materially altering the pulse width characteristics of the pulsed laser beam. With that in mind the present inventor recognized that such reduced pulse spreading of focused excitation light can provide good axial resolution and accomplish simultaneous multi-photon excitation across a larger plane of the specimen than is possible for a system wherein unfocused parallel light is provided to the objective lens as disclosed in the system examples of the '862 application. In another embodiment, the beam expansion unit 20 is designed to provide the same focusing of the excitation light as a convex lens, but with a reduction in the disparity of pulse spreading across the light field when compared to the convex lens. The present inventor has recognized that such homogeneous pulse spreading of a focused excitation light can minimize distortion and provide a good image of the larger multi-photon excitation plane. Preferably, the beam expansion unit 20 reduces the pulse spreading characteristics of the excitation light by both reducing the overall pulse spreading and reducing the disparity of pulse spreading across the excitation light.

Further, beam expansion unit 20 is preferably configured to focus the excitation light beam while reducing attenuation characteristics of the light. As used herein, the term reducing attenuation characteristics means that the beam expansion unit 20 focuses the excitation light with less attenuation characteristics than would result from a convex/concave focusing lens that is not designed to reduce attenuation of the excitation beam. Attenuation characteristics include an overall amount of attenuation for the excitation light field or disparity of attenuation across the excitation, or a combination of these factors. Thus, in a preferred embodiment, the beam expansion unit 20 is designed to provide the same focusing or convergence of the excitation light as a given convex lens, but with an overall reduction in attenuation and a reduction in the disparity of attenuation of the light when compared with the convex lens. This can provide intensity of the excitation light that is substantially constant across the area of the focused beam. In another embodiment, the beam expander provides an expanded excitation beam that has substantially the same intensity as the excitation light emitted from the pulsed laser source and/or has substantially the same disparity in intensity as the excitation light emitted from the pulsed laser source.

Having recognized the importance of reduced pulse spreading characteristics and reduced attenuation characteristics, the present inventor has further recognized that these characteristics of a conventional focusing lens are affected by the amount of medium that the laser beam must travel through. Specifically, because focusing lenses present a thick medium (for example, glass) for the light to pass through, the dispersion characteristics of the medium causes pulse spreading and attenuation of the light. Further, the non-uniform focused beam from commercial focusing units is due to such units being designed such that different portions of the laser beam entering the convex focusing lens travel through different amounts of the lens medium. More specifically, since pulse spreading and light attenuation are affected by the amount of medium that the laser beam must travel through, peripheral portions of the focused beam, for example, may have different pulse spreading and attenuation characteristics than a center portion of the focused beam. Thus, the focusing unit of the present invention is specially designed to allow the laser beam to travel through substantially the same amount of glass (or other lens material) at each point of the focused beam.

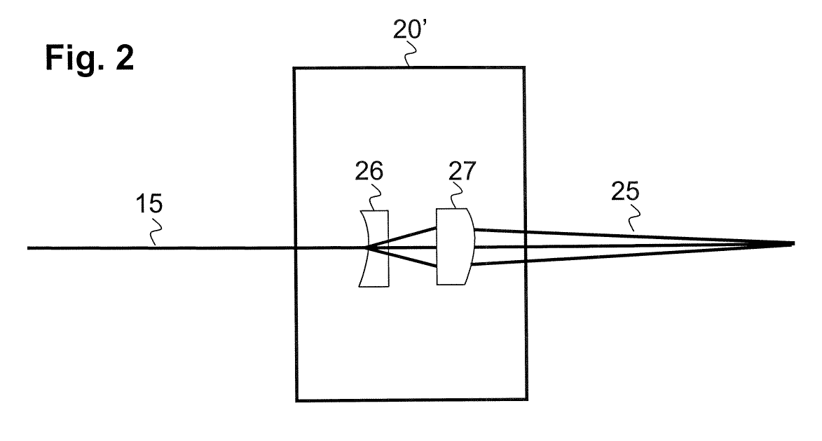

A beam expansion unit according to one embodiment is schematically shown in FIG. 2. As seen in this figure, the beam expansion unit 20 includes a first lens 26 designed to expand laser beam 15, and a second lens 27 designed to then provide a converging but expanded laser beam 25 with essentially the same pulse spreading characteristics as the input laser beam 15. The beam expander 20′ is designed such that the laser beam travels through substantially the same amount of glass at all points across the beam so that there is uniform pulse spreading across the field. A similar design approach may be used to provide an expanded parallel excitation beam 25.

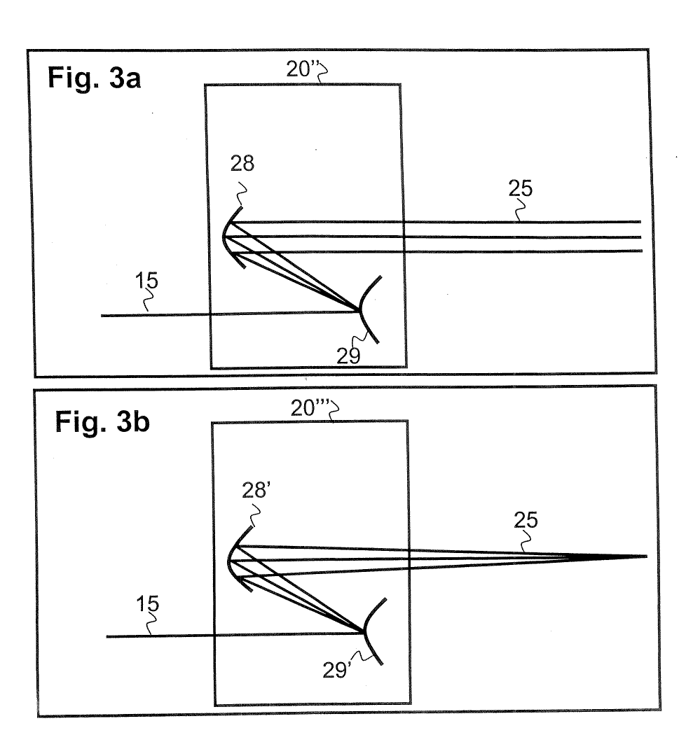

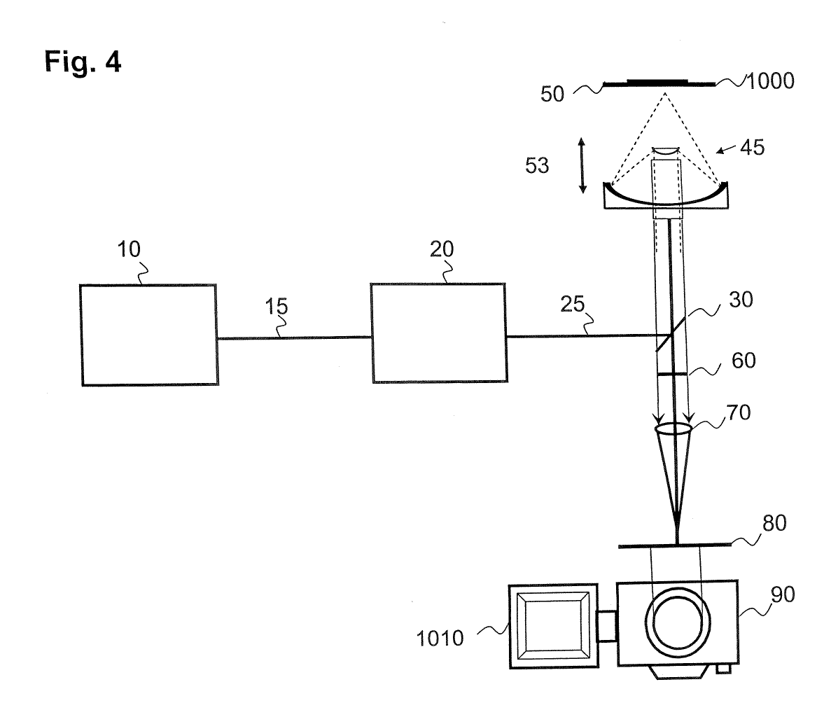

FIGS. 3a and 3b show beam expansion units 20″ and 20′″ in accordance with an alternate embodiment of the present invention. In this case the beam expansion is accomplished by a reflective process without passing the laser beam through any dispersive media. As seen in FIGS. 3a and 3b, the beam expansion unit is based upon a positive mirror and a negative mirror. The focal properties of the positive mirror 29 and negative mirror 28 shown in FIG. 3a expand laser beam 15 resulting in expanded beam 25 which is not converging and remains parallel. Because the laser beam has not passed through any dispersive material, the expanded beam 25 has almost identical pulse characteristics across the whole expanded beam as is present in the input beam 15. The focal properties of the positive mirror 29′ and negative mirror 28′ shown in FIG. 3b expand laser beam 15 resulting in expanded beam 25 which is converging and comes to a point of focus, such point of focus can be at the back aperture of microscope objective 40 shown in FIG. 1 or reflective microscope objective 45 as shown in FIG. 4. Because the laser beam has not passed through any dispersive material during the beam expansion, the expanded beam 25 has almost identical pulse characteristics across the whole expanded beam as is present in the input beam 15.

A focused excitation beam, for example, from the beam expansion unit 20, 20′, 20″, or 20′″ is applied to dichroic mirror 30, which is designed to reflect a certain wavelength range and pass a different wavelength range. A characteristic of a multi-photon fluorescence microscopy system is that the excitation light has a substantially different wavelength than the wavelength of the fluorescent emission of the specimen. For example, the excitation wavelength is typically provided at approximately twice the wavelength (i.e. approximately one half the single photon energy) that is necessary for fluorescent emission of the specimen. When two or more excitation photons excite the specimen in a time period less than the characteristic decay time of the fluorescent material in the specimen, the specimen is excited to an energy level as if it were excited by a more energetic single photon, and therefore emits an emission photon whose wavelength is higher (lower energy) than the single photon excitation wavelength. The emission wavelength depends upon the physio-chemical characteristics of the fluorescent dye. Multi-photon excitation can be similarly achieved by use of 3 photon excitation wherein the excitation light is 3× the excitation wavelength. Greater multiples of the excitation wavelength may also be used to achieve higher multiples of multi-photon excitation.

Thus, in the embodiment of the invention shown in FIG. 1, the dichroic mirror 30 reflects the longer wavelength excitation light and passes the shorter wavelength emission light. Dichroic mirrors are well known to those skilled in the art of optical components. Moreover, any known optical component for achieving the same function of a dichroic mirror may be used in place of the mirror 30.

The objective 40 is an infinity corrected objective lens device having a rear lens portion 42 for receiving the focused excitation light beam from the dichroic mirror 30, and a front lens portion 44 for focusing the excitation beam onto a focus plane of the specimen. As with the beam expansion unit 20 described above, the infinity corrected objective 40 is preferably designed to provide minimal power attenuation and reduced spreading of the ultra-short excitation laser pulses. Moreover, the infinity corrected objective 40 can provide a wide variety of numerical aperture (NA) and magnification power characteristics. Table 1 provides a listing of exemplary NA and power characteristics that can be provided by the infinity corrected objective 40.

TABLE 1

| N/A | Mag. Power |
|---|---|
| .10 | 4 |
| .25 | 10 |
| .75 | 20 |
| .4 | 32 |
| 1.25 | 40 |
| 1.3 | 100 |
| 1.4 | 40, 60, 63, 100 |

### As should be understood by one of ordinary skill in the art, other NA and magnification power lenses can be used to achieve the desired resolution and magnification for a particular application.

The front lens portion 44 of the infinity corrected objective 40 converges the excitation light onto a planar area such that sufficient photon density exists across a predetermined area of the focal plane to cause simultaneous multi-photon excitation of fluorescent material in a relatively large area corresponding to the predetermined area of the focal plane. Such a relatively large area allows viewing of an image through an optical detector such as a binocular eyepiece, for example. In addition simultaneous excitation of a large area of the specimen allows simultaneous detection of at least two pixels at the microscope image detector. However, the embodiment of FIG. 1 provides the axial resolution desired for clear image slices, as will be described further below. Thus, the stage 50 that holds the specimen is preferably movable relative to the objective lens in an axial direction of the light beam as represented by the arrow 53 in the FIG. 1. This relative movement provides focusing of the excitation plane at different depths of the specimen so that 3-D imaging of the specimen can be performed.

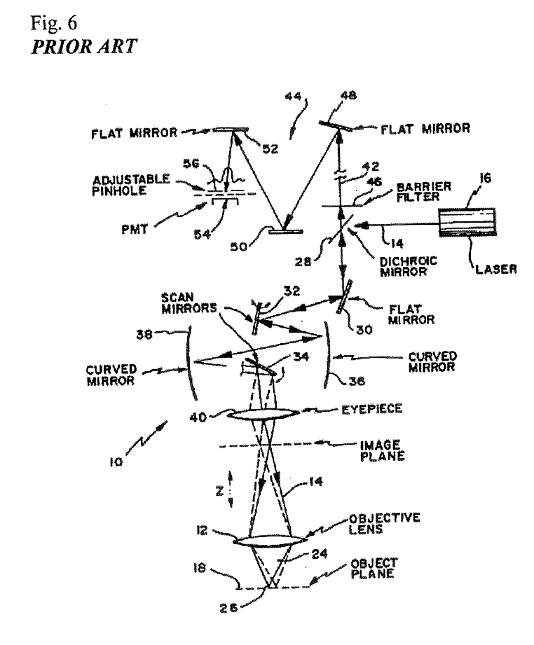

FIG. 4 shows an arrangement of the invention in which reflective optics are used in the design of the microscope objective. The inclusion of a reflective Schwarzchild microscope objective (for example Edmund Optics T58-418 and others) into the system creates conditions for further minimizing pulse spreading and providing a more optimal and uniform multiphoton effect since all of the surfaces in the system can be reflective rather than dispersive. Inclusion of such a reflective objective even in scanning multiphoton systems (such as that shown in FIG. 6, for example) would be expected to improve their multiphoton performance. In FIG. 4 the beam expansion system is preferably based upon the reflective optics 28 and 29 discussed in FIGS. 3a and 3b, and incorporates reflective optics in objective 45. As seen in FIG. 4, the expanded excitation beam (parallel or converging) is made incident on convex reflector 46, which reflects the excitation light to the concave reflector 47. The concave reflector then converges the excitation light to the specimen 1000. Emission light passes back through the objective in reverse order, first incident on reflector 47 and then on reflector 46.

The relative movement of stage 50 may be provided by moving the stage in an axial direction relative to a fixed objective 40, 45, or moving the objective 40, 45 relative to a fixed stage 50. Movement of both the stage 50 and objective 40, 45 can also be provided. Moreover, movement of the stage 50 and/or objective can be provided by manual or automated movement configurations well known to those skilled in the art of microscopy. For example, axial movement can be provided by an electric motor and gear assembly, or a piezoelectric actuator assembly. This automated movement may be computer controlled as also know to those skilled in the art of microscopy.

Emission light collected from the predetermined excitation area of the specimen passes back through the front lens portion 44 of the infinity corrected objective 40 and exits the rear lens 42 portion (in FIG. 1, for example) as a substantially parallel beam directed toward the dichroic mirror 30. As noted above, the dichroic mirror 30 is designed to reflect the wavelength of the excitation light 25 and pass the wavelength of the emission light 55. Thus, the dichroic mirror 30 functions as a device for separating the emission light 55 from the excitation light 25. The emission filter 60 blocks wavelengths other than the emission wavelength, and the filtered parallel emission beam is then applied to the focusing lens 70. As the emission beam is substantially parallel, the focusing lens 70 is provided to converge the emission beam onto an image plane 80 so that an image of the specimen can be detected and viewed. The focusing lens may be a tube lens or any other known lens for focusing the parallel beam of emission light on an image plane 80. In the embodiment shown in FIG. 1, the image plane 80 corresponds to a detection device 90. The detection device 90 can be a simple optical detector such as the binocular eye piece a video camera, a cooled CCD camera, electron bombardment CCD camera or any other known device for detecting an image.

The wide-field multi-photon microscopy system of FIG. 1 provides simultaneous multi-photon excitation across a focal plane with good axial resolution and a wider field of view than the example parallel beam system described in the '862 application. Specifically, unlike the parallel beam system disclosed in the '862 application, the excitation beam of inventive FIGS. 1-4, for example, is applied to the objective 40 or 45 as a focused beam with reduced pulse spreading characteristics and reduced attenuation characteristics. In a preferred embodiment, the focused excitation beam is provided by positive and negative mirrors rather than a focusing lens, which the present inventor recognized will reduce pulse spreading characteristic to facilitate better excitation across a relatively large area confocal plane.

By providing a confocal plane of excitation, the wide-field microscopy system of the present invention reduces the need for scanning of the excitation beam. In a preferred embodiment the excitation plane covers the desired viewing area so that no scanning mechanism is needed at all, such as with the embodiment of FIGS. 1 and 4. However, where the desired image viewing area is too large for simultaneous multi-photon excitation to take place, some scanning of the wide-field system in the xy direction can be used to provide improved images that are combined to provide an image slice covering of the desired area of the specimen. For example, it is sufficient that the simultaneous multi-photon excitation area of the specimen cover at least two pixel regions (preferably a 2×2 pixel array) of the microscope detector. Where an optical detector such as a binocular eyepiece is used, it is sufficient that the simultaneous multi-photon excitation area cover an area that can be viewed by the user through the eyepiece. Adjustment of the simultaneous excitation area can be easily implemented by one of ordinary skill in the art. For example adjustment can be performed by changing the relative placement of the optical elements in the beam expander. In addition to reduced scanning, the present invention produces improved image slices due to improved contrast resulting from a reduction of background fluorescence, and further reduces the problems of bleaching and tissue damage over prior art wide-field systems.

Still further, the wide-field microscopy system of the present invention can provide improved image acquisition time. Specifically, the reduction or elimination of scanning of the excitation beam allows more time for exposure, which results in a faster acquisition time. Moreover, although image acquisition time is related to the beam intensity at the focal point, which is distributed over a wide area for the wide-field system of the present invention, improvements in efficiency provided by the wide-field system may require none or small increases in the exposure time necessary for the wide area being simultaneously viewed. Specifically, the excitation light source of prior art focus point multi-photon microscopy systems is typically attenuated to avoid tissue damage of the specimen. The wide-field multi-photon microscopy system of the present invention can use the full power of the excitation light source and distribute this power over a large planar area so that the average power over the area is still below the threshold power for tissue damage. Thus, the exposure time for the larger area does not need to be increased over the time for conventional small area exposures because such small area exposures typically use an attenuated beam, which the present invention avoids.

Even assuming no efficiency improvements provided by the present invention, a reduced or non-scanning microscope of the invention will result in little or no increase in image acquisition time over that necessary using the current point scanning technique in which a higher power spot is scanned over the same area. For example, it may take 1 second to scan a 1000×1000 pixel image (each pixel is exposed for 1 microsecond) using a conventional scanning microscope. In the current invention the beam can be expanded to expose the whole 1000×1000 pixel image with a 1 second exposure time for collecting emission light. In this case with the expanded beam, each pixel sees 1,000,000 times less excitation energy, however the exposure time is increased 1,000,000 times, thus the net imaging result is the same.

The embodiments of the invention of FIGS. 1, 2, 3 and 4 have been described with respect to a microscope having an excitation source and a lens system positioned below the specimen on a stage. However, a wide-field multi-photon microscopy system of the present invention may be implemented as an upright microscope, which has the excitation system above the stage and the lens system above the stage. Moreover, the wide-field multi-photon microscopy system of the present invention may be implemented in conjunction with a focal point system. Specifically, a focused beam can be applied to the specimen and raster scanned for laser ablation, while a wide-field beam can be applied for multi-photon excitation and detection. Moreover, multiple wide-field excitation beams according to the present invention can be arranged in parallel. It is noted, however, that this implementation of the present invention does not need to scan the wide-field beam arrays. These systems can be readily implemented by one of ordinary skill in the art having the knowledge of the present invention as disclosed herein.

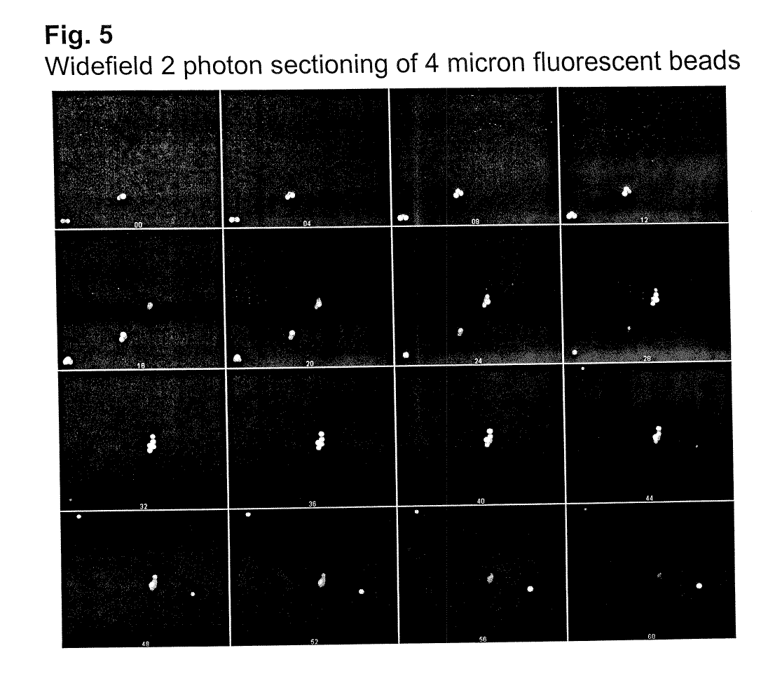

Still further, the wide-field multi-photon microscopy system of the present invention may be implemented as a flexible scope used for example, in in vivo imaging. FIG. 5 of the 862 application, which is incorporated herein by reference, demonstrates a flexible scope utilizing the wide-field multi-photon excitation techniques of the present invention. The system includes an external unit coupled to an optical fiber having an objective at a distal end of the fiber remote from the external unit. The objective includes only a focusing lens corresponding to the front lens described with respect to FIG. 1. The infinity corrected objective lens, tube lens, excitation light source as well as any other optical components are provided within the external unit. However, the infinity corrected lens and other optical components may be implemented into the objective lens unit of the fiber in order to reduce pulse spreading of the pulses excitation laser beam. Moreover, the optical fiber may be implemented as a plurality of individual fibers, and may be enclosed in a catheter tube.

### EXAMPLE PREFERRED EMBODIMENTS

### Example 1

A Zeiss Axiovert 135 (Carl Zeiss, Germany) widefield microscope with motorized Z focus motor and epifluorescence equipment can be modified for 2-photon widefield fluorescence according to the present invention. The objectives include Zeiss 10×, 20×, 40×, 63× and 100× Plan-neofluar and Plan-Apcromats, with the NA of the objectives ranging from 0.4 to 1.4. One position in the fluorescence filter slider contains special filters to accommodate 2-photon excitation and emission. The dichroic mirror and excitation and emission filters contain no filter on the excitation side and a special dichroic mirror from Chroma Technology Corporation, Rockingham, Vt. which reflects light above 700 nm and passes wavelengths below 700 nm. Various bandpass emission filters between 450 nm and 700 nm can be used, depending upon the dye and wavelength of pulsed laser illumination. The arc lamp and the optical components in the epi-illumination path were removed from the microscope and a femtosecond tunable laser and beam expansion optics inserted as a substitute excitation source in the system.

The laser was a Coherent, Inc. of Santa Clara, Calif. tuneable Camelion femtosecond laser, tuneable in the 700-1100 nm range, is substituted for the arc lamp illumination system. The beam expansion unit shown in FIG. 3b which maintains the coherence of the laser beam and uniformity of the femtosecond pulse width of the laser across the expanded beam was positioned between the output of the laser and the input to the microscope excitation path. Thus, the beam was expanded as shown in FIG. 3b to send converging femtosecond laser pulses into the back aperture of a 40× Zeiss na 1.3 oil objective.

A Hamamatsu (Japan) Orca cooled CCD Camera is fitted on the microscope to record fluorescent images. Commercial software (Universal Imaging MetaMorph, Downingtown, Pa.) was used to control the focus on the microscope, the camera, and to acquire the images. A separate computer was used to control the Camelion laser for selection of laser characteristics and wavelength of 2-photon excitation. The image acquisition software communicates with the computer controlling the Camelion laser through a serial line to select the excitation wavelength. The laser power at 700 nm was attenuated to 3% of the maximum laser power of 1.3 watts with a beam splitter before the beam entered the beam expansion unit.

The results of imaging 4 micron fluorescent beads with a converging beam are shown in FIG. 5. Images of a grouping of stacked beads were acquired at 0.25 micron Z step intervals, and the exposure time for each image was 500 msec. In FIG. 5, each 4^{th} image is displayed such that each image would be larger and the sectioning detail and resolution better seen. As can be seen in FIG. 5, excellent sectioning of the beads was possible with the system. Specifically, in viewing the images in sequence, it can be seen that beads in the initial image “00” become more clear in the confocal plane with each image. However, as the confocal plane increments in the Z direction, the initial beads are no longer visible by image “32.” However, as the confocal plane moves, different beads come within the confocal plane and can be viewed.

Fluorescent images from live cells grown on 25 mm glass coverslips mounted in an Attofluor stainless steel coverslip holder (Molecular Probes, Eugene Oreg.) can be imaged with the 2-photon microscope. In the case of live cells, intracellular calcium, for example can be imaged in cells loaded with the ratio dye fura-2 AM (excitation 705 nm and 760 nm, emission 500 nm-520 nm) or fluo-4 AM (excitation 970 nm, emission 520 nm). Slides prepared from cultured cells and tissues sections from a variety of cell types and tissues can be imaged for specific antigens by reacting the slides with specific antisera and using fluorescently labeled second antibodies to detect the primary antibody on the slides. Secondary antibodies labeled with Alexa 350, Alexa 488 and Alexa 546 are used to detect the primary antibodies. These dyes can be excited separately or simultaneously with 700 nm, 976 nm and 1092 nm light from the femtosecond laser. A multibandpass emission filter (Chroma 61003 m) was used to monitor the emission at each wavelength.

### Example 2

A Pathway HT High Content Screening microscope (Atto Bioscience, Inc. can be modified for 2-photon widefield fluorescence according to the present invention. The objectives includes Zeiss 10×, 20×, 40×, 63× and 100× Plan-neofluar and Plan-Apcromats and Olympus 20× 0.75 NA and 60× 1.4 NA objectives. The dichroic mirror and excitation and emission filter wheels contained no filter on the excitation side and a special dichroic mirror from Chroma Technology Corporation, Rockingham, Vt. which reflects light above 700 nm and passes wavelengths below 700 nm can be inserted in the excitation/emission filter wheel. Various bandpass emission filters between 450 nm and 700 nm can be used, depending upon the dye and wavelength of pulsed laser illumination. The arc lamp and other optical components in the epi-illumination path for lamp two can be replaced with a SpectraPhysics (Mountain View, Calif.) tuneable MaiTai femtosecond laser, tuneable in the 700-1100 nm range. To improve performance all prisms in the instrument can be replaced with reflective mirrors.

A custom designed beam expansion unit (such as that of FIG. 3a or 3b), which either focuses the laser beam upon the back aperture of the microscope objective (FIG. 3a) or provides parallel light to the back aperture (FIG. 3b) and uniformity of the femtosecond pulse width of the laser across the expanded beam is positioned between the output of the laser and the input to the microscope excitation path. A Hamamatsu (Japan) Orca-ER cooled CCD Camera in the instrument can record fluorescent images. Software inherent to the instrument is used to control the focus of the microscope, the objective position, the camera and to acquire the images. A separate computer is used to control the MaiTai laser for selection of laser characteristics and wavelength of 2-photon excitation. The image acquisition software communicates with the computer controlling the MaiTai laser through a serial line to select the excitation wavelength.

Fluorescent images from live cells grown on 25 mm glass coverslips mounted in an Attofluor stainless steel coverslip holder (Molecular Probes, Eugene Oreg.) can be imaged with the 2-photon microscope. In the case of live cells, intracellular calcium, for example can be imaged in cells loaded with the ratio dye fura-2 AM (excitation 705 nm and 760 nm, emission 500 nm-520 nm) or fluo-4 AM (excitation 970 nm, emission 520 nm). Fixed or living cells in multi-level plates labeled with fluorescent dyes can be monitored for their fluorescent emission by the present invention for high throughput or high content drug screening. Slides prepared from cultured cells and tissues sections from a variety of cell types and tissues can be imaged for specific antigens by reacting the slides with specific antisera and using fluorescently labeled second antibodies to detect the primary antibody on the slides. Secondary antibodies labeled with Alexa 350, Alexa 488 and Alexa 546 can be used to detect the primary antibodies. These dyes can be excited with 700 nm, 976 nm and 1092 nm light from the femtosecond laser. A multibandpass emission filter (Chroma 61003 m) was used to monitor the emission at each wavelength.

Obviously, numerous modifications and variations of the present invention are possible in light of the above teachings. It is therefore to be understood that within the scope of the appended claims, the invention may be practiced otherwise than as specifically described herein.

1. A wide-field microscope comprising:
a stage configured to hold a specimen having a fluorescent material therein;
a multi-photon excitation light source configured to produce excitation light having a single photon energy less than an absorption energy required for single photon excitation of said fluorescent material;
a beam expansion unit optically coupled to the light source and configured to expand the excitation light with reduced pulse spreading characteristics;
an infinity corrected objective optically coupled to the expansion unit and configured to focus the excitation light onto the specimen such that multi-photon excitation of the fluorescent material simultaneously occurs over a predetermined area of the specimen; and
a focus lens configured to focus emission light emitted from said predetermined area of the specimen onto at least two pixels of an image detector simultaneously.

2. The wide filed microscope of claim 1, wherein the beam expansion unit is configured to provide a converging expanded beam of excitation light.

3. The wide-field microscope of claim 2, wherein said microscope is not configured to scan the converging expanded beam of excitation light in an x or y direction across the specimen, the wide-field microscope further comprising a dichroic mirror configured to reflect the excitation light toward the infinity corrected objective lens and to pass the emission light through the dichroic mirror toward the focus lens.

4. The wide-field microscope of claim 3, wherein the dichroic mirror comprises a surface configured to reflect relatively long wavelength excitation light and pass therethrough shorter wavelength emission light, the wide-field microscope of claim 1, further comprising a movement system configured to adjust the distance between the infinity corrected objective lens and the specimen held on the stage

5. The wide-field microscope of claim 1, wherein
said multi-photon excitation light source comprises a pulsed laser light source configured to provide a picosecond, femtosecond, or shorter pulse duration, and
the beam expansion unit is configured to provide substantially no pulse spreading of the pulsed laser light.

6. The wide-field microscope of claim 1, wherein:
said multi-photon excitation light source comprises a pulsed laser light source configured to provide a picosecond, femtosecond, or shorter pulse duration, and
the beam expansion unit is configured to provide an expanded pulsed laser beam having substantially uniform characteristics across an area of the expanded pulsed laser beam.

7. The wide-field microscope of claim 1, wherein said beam expansion unit is configured to provide a converging expanded beam of excitation light with reduced attenuation characteristics.

8. The wide-field microscope of claim 1, wherein the focusing unit is configured to present a substantially equal amount of optical medium to all light of the expanded beam.

9. The wide-field microscope of claim 1, wherein the laser comprises a tunable laser tunable between approximately 700 nm and approximately 1100 nm.

10. The wide-field microscope of claim 1, wherein the infinity corrected objective comprises:
a front lens portion configured to focus a beam; and
a rear lens portion configured to maintain a beam substantially parallel.

11. The wide-field microscope of claim 1, wherein the infinity corrected objective lens device comprises an objective having a magnification power between approximately 4 to 100 and a numerical aperture (NA) between approximately 0.10 10 1.4.

12. The wide-field microscope of claim 1, wherein the multi-photon excitation light source is configured to produce excitation light having a photon energy that causes excitation of the specimen only when 2 or more photons are substantially simultaneously absorbed by the fluorescent material.

13. The wide-field microscope of claim 17, wherein the multi-photon excitation light source is configured to produce excitation light having a photon energy that causes excitation of the specimen only when 3 or more photons are substantially simultaneously absorbed by the fluorescent material.

14. The wide-field microscope of claim 1, wherein said beam expansion unit comprises at least one positive mirror configured to expand the excitation light and at least one negative mirror, configured to converge the expanded excitation light into a converging beam.

15. The wide-field miscroscope of claim 1, wherein said beam expansion unit comprises at least one positive mirror configured to expand the excitation light and at least one negative mirror configured to provide a parallel expanded beam from said expanded excitation light.

16. The wide-field miscroscope of claim 1 wherein said beam expansion unit comprises at least one concave lens and at least one convex lens, said lenses configured to converge the excitation light into a converging expanded beam of excitation light.

17. A wide-field microscope comprising:
means for holding a specimen having a fluorescent material therein;
means for producing excitation light having a single photon energy less than an absorption energy required for single photon excitation of said fluorescent material;
means for expanding the excitation light with reduced pulse spreading characteristics;
means for focusing the excitation light onto the specimen such that multi-photon excitation of the fluorescent material simultaneously occurs over a predetermined area of the specimen; and
means for focusing emission light emitted from said predetermined area of the specimen onto at least two pixels of an image detector simultaneously.

18. The wide-field microscope of claim 17, further comprising means for reflecting the excitation light toward the means for focusing the excitation light and passing the emission light to the means for focusing the emission light.

19. The wide-field microscope of claim 18, further comprising means for filtering the emission light, the means for filtering being disposed in the optical path between the means for reflecting and means for expanding the excitation light.

20. The wide-field microscope of claim 18, further comprising means for moving the specimen relative to the means for expanding the excitation light.

21. The wide-field microscope of claim 18, further comprising means for detecting an image focused on the image plane.

22. The wide-field microscope of claim 21, further comprising means for combining multiple detected images into a three dimensional image of the specimen.

23. A wide-field microscope comprising:
a stage configured to hold a specimen having a fluorescent material therein;
a multi-photon excitation light source configured to produce excitation light having a single photon energy less than an absorption energy required for single photon excitation of said fluorescent material;
an optical coupling system optically coupled to the light source and configured to couple the excitation light;
a reflective infinity corrected objective optically coupled to the optical coupling system and configured to focus the excitation light onto the specimen such that multi-photon excitation of the fluorescent material simultaneously occurs over a predetermined area of the specimen; and
a focus lens configured to focus emission light emitted from said predetermined area of the specimen onto at least two pixels of an image detector simultaneously.

24. The wide-field microscope of claim 23, wherein the reflective infinity corrected objective comprises a reflective Schwarzchild microscope objective.
